(19) United States
(12) Patent Application Publication
(10) Pub. No.: US 2010/0239853 A1
(43) Pub. Date: Sep. 23, 2010

(54) OBJECT COMPRISING AN ADHESIVE LAYER, AND COMPOSITION AND METHOD OF COATING THEREOF

(75) Inventors: Andreas Hartwig, Ritterhude (DE); Kerstin Albinsky, Weyhe (DE); Monika Sebald, Ritterhude (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FRAUNHOFER-GESELLSCHAFT ZUR FORDERUNG DER ANGEWANDTEN FORSCHUNG E.V., Munchen (DE)

(21) Appl. No.: 12/669,021

(22) PCT Filed: Jul. 14, 2008
(86) PCT No.: PCT/EP08/05734

§ 371 Date: May 18, 2010

(30) Foreign Application Priority Data
Jul. 14, 2007 (DE) 10 2007 032 955.7

(51) Int. Cl. C09J 7/02; B32B 5/16

(52) U.S. Cl. 428/328; 428/323; 428/331; 524/560

(57) ABSTRACT

The invention relates to an adhesive composition with an adjustable separating force, which contains an aqueous polymer dispersion and inorganic particles, preferably nanoparticles, and also to the use thereof. Furthermore, the invention relates to an object having an adhesive layer which can be obtained by drying the above-mentioned adhesive composition, in particular to a flat carrier material, such as paper or a film.

### TECHNICAL FIELD

The invention relates to an adhesive composition with an adjustable separating force, which contains an aqueous polymer dispersion and inorganic particles, preferably nanoparticles, and also to the use thereof. Furthermore, the invention relates to an object having an adhesive layer which can be obtained by drying the above-mentioned adhesive composition, in particular to a flat carrier material, such as paper or a film.

### STATE OF THE ART

Contact adhesives for gluing paper and other substrates are normally geared towards high strength and permanence. The contact adhesives for labels or decorative films may be mentioned by way of example. This is achieved in that, to the basic polymers which are used, adhesive resins, so-called tackifiers, are added.

However there are also applications in which value is placed on a low separating force and good detachability. The known adhesive notes are the most important example. The adhesive used for this purpose comprises polymer balls with a low glass transition temperature and diameters of approx. 5 to 50 μm. These balls are partially crosslinked and therefore remain on the carrier substrate after application, do not therefore film together to form a uniform layer. Apart from the permanence of the ball shape, adhesives of this type do not basically differ from the composition of other contact adhesives. Adhesives of this type are disclosed for example in U.S. Pat. No. 3,691,140 and in DE 28 36 319 C2. Because of the ball shape, the contact surface with the substrate to be glued is significantly reduced relative to a uniform layer, which is the main cause of the low separating forces.

The ball shape has the disadvantage however, relative to a closed layer, that the adhesion on the carrier material (e.g. the note) is also low. As a result, transfer of the adhesive onto the substrate to be glued is effected so that, after removing the note, residues remain and soil the surfaces. In addition, the quantity of adhesive on the self-adhesive note is reduced as a result of which the adhesion on a substrate is reduced when reapplied.

The slight transfer of the adhesive onto a substrate has the result in addition that, when producing blocks or rolls made of paper or film which are equipped to be self-adhesive, a release layer (anti-adhesive layer) must be applied on the side which is not equipped to be adhesive. Since this release layer is intended also to be able to be written on in most cases, entirely opposing requirements must be fulfilled here. This additional layer is associated with high costs.

In the case of mechanical application of papers or films provided with adhesives of this type, the slight transfer of adhesive has a further crucial disadvantage, namely soiling of the machine parts over which the materials provided with adhesive must be guided. As a result, very high outlay on cleaning is required or mechanical transport of these carrier materials is not at all possible. This relates in particular to self-adhesive, roll-shaped printing media, such as e.g. till rolls. When using contact adhesives known from the state of the art, which have a low adhesive force, in order to equip with till rolls of this type, frequent cleaning of the paper transport mechanism of the tills would be required.

In DE 102 59 460 A1=WO 2004/056881 A1, the addition of nanoparticles to form a contact adhesive compound is described in order to increase the cohesion and cuttability thereof. This is achieved in that the acrylate is polymerised in a homogeneous phase in the presence of an organic non-aqueous solvent.

### DESCRIPTION

The object therefore underlying the invention is to avoid the disadvantages of the state of the art at least partially and to indicate an adhesive composition which, after it has been applied on a carrier material, has only a relatively low adhesive force and also to indicate an object having an adhesive layer applied in this manner. Preferably, the adhesive composition should make it possible for carrier materials to be able to be produced herefrom with an adhesive layer, in the case of which a release layer can be dispensed with.

This object is achieved by the coated flat object according to claim 1. Claim 12 relates to the adhesive composition and claim 20 to the use of the adhesive composition. Further advantageous embodiments are contained in the dependent claims.

The coated flat object according to the invention can be obtained by coating a flat carrier material with an adhesive composition, subsequent drying of the thus coated carrier material and possibly subsequent treatment following the drying. Firstly, the adhesive composition used for this purpose is described in more detail.

According to the invention, the adhesive composition contains a polymer dispersion, the polymer contained in the polymer dispersion having a glass transition temperature of less than 20° C., and also inorganic particles with an average particle size between 1 nm and 50 μm.

Surprisingly, it was shown that, with mixtures of this type, adhesive layers which have reduced adhesive forces can be produced on substrates—in particular reduced relative to the adhesive force of a composition which contains no inorganic particles. These adhesive forces can be adjusted specifically by the quantity and type of inorganic particles. If the adhesive composition according to the invention is applied on a carrier material, then a self-adhesive layer with a low adhesive force is obtained after drying. Differently from adhesive compositions with a low adhesive force according to the state of the art, this is not transferred partially onto a substrate to be glued and the components thereof also do not become deposited in machines which contain the coated carrier material (e.g. cash registers) for example in transport devices. The adhesive composition according to the invention is therefore distinguished in particular in that, after it is applied and dried onto the carrier material, it adheres on the carrier material so firmly that no transfer of the resulting adhesive layer or a part of the adhesive layer or a part of the components contained in the adhesive layer onto a substrate to be glued is effected. The resulting adhesive force on coated paper as substrate, measured with a 180° peeling test and a testing rate of 80 mm/min, is hereby generally at most 0.06 N/mm.

The adhesive composition also has the advantage that, in the case of a flat object coated with this adhesive composition, the release layer (anti-adhesive layer) which is required according to the state of the art can be dispensed with.

If inorganic particles with a primary particle size of less than 100 nm (nanoparticles) are used, then a coating which is transparent is obtained with the polymer dispersion, which is advantageous for example when coating films. In addition, formulations of this type allow particularly thin and homogeneous adhesive layers.

The adhesive compositions according to the invention based on aqueous polymer dispersions basically differ from solvent-based contact adhesives since these polymer dispersions are heterogeneous systems which usually also contain surfactants and/or ionic groups for stabilisation of the suspension. In contrast to WO 2004/056881 A1, it is also not important with the composition according to the invention that the adhesion force is increased. Rather it is essential that, by means of suitable choice of the components of the adhesive composition, the adhesive force (i.e. the adhesion force) can be adjusted and in particular can be reduced relative to the corresponding composition which contains no inorganic particles.

In order to produce the adhesive composition according to the invention, one or more aqueous polymer dispersions is mixed with the fine-particulate inorganic particles and mixed until a homogeneous mixture is present.

Preferably, the proportion of inorganic particles in the adhesive composition is at most 50% by weight, relative to the polymer content of the polymer dispersion. For particular preference, the proportion of inorganic particles is 0.5 to 15% by weight, relative to the polymer content of the polymer dispersion. In the case of higher contents, the adhesive force is generally too low, with lower contents an adequate effect can generally no longer be established.

According to the invention, aqueous polymer dispersions are used, the polymer having a glass transition temperature below 20° C. The glass transition temperature is hereby determined according to DIN 53765. Preferably the glass transition temperature is below 0° C. since otherwise, at normal temperatures of use, no adhesion capacity or one varying greatly with temperature is present.

In one embodiment, the average particle size of the polymers of these polymer dispersions for the coated flat object and the adhesive composition is 20 to 700 nm, preferably 50 to 400 nm and particularly preferred 50 to 200 nm. Like all other particle sizes indicated with respect to this invention, this is determined by light scattering according to the following literature sites: L. B. Aberle et al. in Phys. Chem. Chem. Phys. 1999, 1, 3917-3921; L. B. Aberle et al. in Applied Optics 1998, 37, 6511-6524. The polymer dispersion for the polymer film of the coated flat object preferably contains polymers which contain polyacrylates, polymethacrylates, polyisoprene, polybutadiene, polyisobutylene, polydimethylsiloxane or polyurethane as main component (i.e. greater than 50% by weight) or as single component. It is thereby also possible that the mentioned polymers are present as main components in a copolymer.

For particular preference, aqueous polymer dispersions based on substituted or unsubstituted acrylic monomers (e.g. acrylic acid- or methacrylic acid esters), in particular polymer dispersions which contain or comprise a polyacrylate and/or a polymethacrylate as main component (greater than 50% by weight). Here also, the pure polymers, mixtures with other polymers or copolymers of these materials are suitable.

Polymer dispersions which contain or comprise polychloroprene as main component are not suitable for the adhesive composition according to the invention since the adhesive force is increased greatly hereby when using nanoparticles.

The aqueous polymer dispersion can also contain polymers in which comonomers are contained, which have, polymerised on their own, higher glass transition temperatures than 20° C. It is merely essential that the glass transition temperature of the polymer which the polymer dispersion used comprises is less than 20° C.

The following substances for example are suitable as comonomers: acrylic acid, methacrylic acid, styrene, methylmethacrylate, ethylacrylate and/or isobornylacrylate.

It is further preferred if the main monomer or the exclusive monomer on which the polymer dispersion is based, is an acrylate or a methacrylate with a hydrocarbon radical which contains more than 6 carbon atoms. In turn, hydrocarbon radicals with 6 to 12 carbon atoms are preferred here, furthermore these hydrocarbon radicals generally concern branched, unbranched or cyclic alkyl radicals. Particularly preferred are polymer dispersions based on isooctylacrylate as main monomer or single monomer.

According to the invention, the coated flat object comprising carrier material and coating is characterised in that the coating has a polymer film, the polymer film not being soluble in a 48-hour treatment at room temperature with a solvent suitable for corresponding oligomers of the monomers contained in the polymer film up to at least 50%, relative to the total polymer content, and the polymer having a glass transition temperature of less than 20° C. and there being contained in the coating inorganic particles with an average primary particle size between 1 nm and 50 μm.

In one embodiment, the polymer film is not soluble up to at least 80%, preferably up to at least 90%.

There are understood according to the invention by oligomers compounds in the molecules of which only a few monomer units (constitutional units) of the same or a different type are repeatedly crosslinked with each other and the physical properties of which change significantly by adding or removing one or more constitutional units (Römpp Chemielexikon, 9., extended and revised edition, eds. J. Falbe and M. Regnitz, Georg Thieme Press, Stuttgart 1991, p. 3107 f)). An oligomer within the scope of this invention should have a polymerisation degree of less than 100, i.e. comprise fewer than 100 repeat units.

Polymers with the same basic composition which have a low to average molar mass and are not crosslinked dissolve in solvents. Typical solvents for polyacrylates (the most important polymers for contact adhesives and hence also the applications according to the invention) are e.g. acetone, methylethylketone or toluene. The insolubility in these solvents shows that the polymers are crosslinked or have such a high molar mass that they become insoluble. The suitable polymer dispersions form dried polymer films which, up to at least 50%, preferably at least 80%, particularly preferred 90% of the total polymer proportion, are not soluble in the solvent which is a good solvent for low-molecular polymers comprising the same monomers after a treatment of 48 h at room temperature. The films formed from these dispersions are slightly swellable. The insoluble component is the gel content as is normally determined for crosslinked polymers.

Unsuitable polymer dispersions dry in contrast to form films which are soluble in the respective solvents. Unsuitable dispersions have no or only very little crosslinking and a high soluble polymer proportion (greater than 50%). In the solvents which dissolve the oligomers made of the corresponding monomers, these filmed dispersions display very strong swelling and are dissolved at least up to 50% within 48 hours at room temperature.

By way of example, the dispersions of Planatol HW 450, Collano DP 7027 and Collano 7024 should be mentioned here. These suitable polymer dispersions reveal no or only a very low dissolving and swelling behaviour in ketones, such as acetone, methylethylketone, alcohols such as ethanol, isopropanol, in aromatics such as toluene and also in acetonitrile as solvent. The dispersions coagulate when using the above solvents. Tests of the solvent phase (acetone) revealed particles with a diameter of approx. 250 nm which correspond to the disperse phase of the dispersion used. Details with respect to soluble proportions were not given.

The partial insolubility of the polymer teaches that partially crosslinked, very high-molecular or greatly branched polymers are required in order to carry out the invention. Without reducing the invention to a specific scientific theory, it is assumed that the partial insolubility of the polymer leads to the polymer and inorganic particles not mixing homogeneously, but rather the particles are located preferably on the surface of the polymer dispersion droplets and hence specifically reduce the adhesive force. This is effected by partial covering of the adhesive with a particle layer so that the contact surface is reduced relative to the substrate.

In an advantageous embodiment, the adhesive composition according to the invention contains a polymer dispersion which is film-forming. There is hereby understood by “film-forming” that the polymer underlying the dispersion is not or only weakly crosslinked as long as it is situated in the aqueous dispersion. Furthermore, there is understood by “film-forming” that the particle shape of the polymer particles which are contained in the polymer dispersion (which can be for example ball-shaped) disappears after drying of the adhesive composition according to the invention and the polymer particles have flowed out to form a layer.

Adhesive compositions of this type have the advantage that a homogeneous adhesive layer can be applied on a carrier material and that therefore the adhesive force of the adhesive layer is also homogeneous.

After application of the adhesive composition, the polymer underlying the dispersion can of course be crosslinked in order to improve for example the intrinsic strength of the adhesive. This can be achieved for instance by UV- or electron irradiation or by using a polymer dispersion which contains comonomers or other components with functional groups which are able to crosslink. For example, glycidylmethacrylate can be used as comonomer during production of the polymer dispersion. The epoxide groups contained can then serve for crosslinking of the adhesive film produced from the adhesive composition. However it should be noted with this embodiment that the molar masses are so high that no homogeneous mixing with the inorganic particles results. As an alternative to the high molar mass, the surface of the inorganic particles can be configured such that a thermodynamic incompatibility (non-miscible) between particles and polymer exists.

There are used as inorganic particles preferably oxides and/or silicates with an average primary particle size between 1 nm and 5 μm, preferably between 5 nm and 100 nm. Particularly suitable are for example silicon oxides, aluminium oxides, titanium dioxides, aluminium silicates, magnesium oxides, barium sulphate and/or zinc oxide. There are hereby understood by an oxide and a silicate all the metal salts which have, as anions, exclusively oxide- and/or silicate ions or, in addition to oxide- and silicate ions, also other anions. There are included for example in the oxides, in particular also the compounds which contain hydroxide groups and/or water (of crystallisation). The inorganic particles are preferably not significantly soluble in water. In particular, the solubility product L of the basic chemical compound in water should be less than 1*10⁻³, preferably less than 1*10⁻⁶. There are suitable therefore also metal salts of the type M (EOₙ)ₘ (M being a metal and E a non-metal, in particular carbon or sulphur and n and m being whole numbers between 1 and 4) which have a solubility product of this type.

Furthermore, the inorganic particles should not be so large that they sediment during further processing, since otherwise a separation of the component can be effected before further processing of the adhesive composition.

Because of the high viscosity which is preferably between 100-2000 mPa·s, measured according to ISO 3219 and/or 100-5000 mPa·s according to Brookfield (spindle 4, 50 rpm) and/or 5-30 Pa·s (spindle 5, 20 rpm) and/or 100-5000 mPa·s (spindle 3, 20 rpm), and because of the high solids content of the aqueous polymer dispersions in the adhesive composition, which preferably has a value of 10 to 70%, particular preferred 30 to 55%, sedimentation is effectively avoided in virtually all combinations of polymer dispersions and inorganic particles. As in all heterogeneous systems, agitation is however recommended shortly before the processing.

The inorganic particles can be present in various preparation forms as also in aqueous dispersions, in the case of silicon dioxide these preparation forms are for example silica sol, quartz powder, pyrogenic silicic acid and/or precipitated silicic acid and/or inorganic particles which were obtained in situ from a silicate solution or from an alkoxysilane.

In particular pyrogenic and precipitated silicic acid are available with very different specific surfaces. Particularly suitable are types with specific surfaces greater than 25 m²/g and particular preferred between 50 and 250 m²/g. Such types are distinguished by a good distribution capacity in the aqueous dispersion and very good stability of the produced particle dispersions. The specific surface was hereby determined by means of BET determination according to DIN 66131.

The particles can be added to the polymer dispersion as dry powder or else be predispersed in water. In order to avoid agglomeration during mixing of the inorganic particles with the polymer dispersion, the inorganic particles are preferably predispersed in water before the addition of the polymer dispersion. This aqueous dispersion of the inorganic particles can contain a series of aids in order for example to prevent sedimentation of the inorganic particles or incompatibility with the polymer dispersion. For example, adaptation of the pH value to the pH value of the polymer dispersion can be effected; however also soluble polymers or surfactants can be added.

If the inorganic particles are present in the form of agglomerates, then the agglomerates can be broken up by shearing the aqueous dispersions strongly. There are suitable for this for example disc dissolvers, ball grinders or rotor-stator mixers. The dispersions of the inorganic particles can however also be produced in situ in the polymer dispersion. For this purpose, the process can start for example with a silicate solution, such as sodium water glass, which is added to the polymer dispersion. Subsequently, the pH value is lowered by the addition of acid so far that solid silicon dioxide is formed from the silicate solution. A further possibility resides in the addition of alkoxysilanes to the polymer dispersion; the alkoxysilanes hydrolyse in the aqueous medium and likewise form silicon dioxide. Especially tetraalkoxysilanes, such as tetraethoxysilane, are suitable for this variant.

Furthermore, silica sol (e.g. Levasil by the company H. C. Starck) can be added to the aqueous polymer dispersion in order to produce the adhesive composition according to the invention. This variant is particularly well suited for the composition according to the invention since silica sol comprises a dispersion of ball-shaped silicon dioxide particles with a diameter of less than 100 nm in water and need not be further processed. It is in addition sedimentation-stable and the slightly alkaline pH value corresponds well to the pH value of many polymer dispersions. Finally, silica sol is non-toxic and economical.

The adhesive force of the adhesive compositions according to the invention can be modified further by the addition of various additives. In addition, mixtures of various polymer dispersions and different particle size distributions of the polymer particles contained in the polymer dispersion, on the one hand, and of the inorganic particles, on the other hand, can be used. If an increase in the adhesive force should be necessary or the glass transition temperature of the formulation is intended to be lowered, typical tackifiers can be added for example as additives, i.e. adhesive resins, as raw materials. They can be incorporated for example during production of the polymer dispersion into the latter, or be added in the form of a dispersion. Examples of adhesive resins of this type are colophony derivatives or hydrocarbon resins (e.g. terpene-, terpenephenol-, C₅-, C₉-, C₅/C₉-hydrocarbon- , pinene- or indene resins).

Furthermore, an additive for modifying the resulting adhesive force can be used. This can be effected in particular by the addition of wax dispersions or silicone resins. These substances generally lead to a reduction in adhesive force and can be advantageous in combination with the inorganic particles.

Furthermore, additives for improving the film-forming behaviour can be added. There are suitable here for example water-soluble polymers, in particular polyacrylic acid, polymethacrylic acid, polyvinyl alcohol or polyacrylamide and/or copolymers derived therefrom.

The object underlying the invention is also achieved by a coated flat object having an adhesive layer, which object can be obtained in particular by coating a flat carrier material as flat object with the above-described adhesive composition and subsequent drying. If required, subsequent processing can be effected, for example by forming a stack having a plurality of layers of the carrier material or rolling up a layer of the carrier material. The carrier material has a flat configuration. It has therefore a shape in the manner of a paper web or a paper sheet or a (plastic material) film. All materials which can be coated as a web material are particularly preferred as carrier material. There are hence possible as carrier material for the coated flat object in particular paper, thermopaper, cardboard, plastic material films, composite films, protective films or mixtures hereof.

A flat substrate can also serve as carrier material, said flat substrate is is or becomes coated, on one side, with the adhesive composition according to the invention and, on the other side, with an adhesive which has a high adhesive force so that an object in the manner of a double adhesive strip or a double adhesive film is produced with 2 sides of a different adhesive force. This makes it possible to provide any object in a simple manner with an adhesive layer comprising the composition according to the invention in that the double adhesive strip/the double adhesive film with the layer which has a high adhesive force is glued onto a surface of this object.

Flat carrier materials with a basis weight below 250 g/m², particularly preferred below 100 g/m², are preferred for the coated flat object.

Because of the low adhesive forces, the coated carriers can be removed easily (from the glued substrate or from a further layer of the coated carrier material) without the risk of tearing because of the low basis weight. The same applies for rolling up a roll coated with the adhesive composition. Also thermopaper which frequently has a low basis weight can be readily coated without the result being a negative influence on the thermolayer.

Preferably, the coated flat carrier material of the coated flat object is present as a stack and/or roll. The adhesive formulation according to the invention is particularly well suited for the production of self-adhesive notes which are made available in the form of blocks or rolls. With these, the sides not provided with adhesive are provided according to the state of the art with an anti-adhesive coating (release coating) in order to avoid transfer of the adhesive onto this side and to ensure easier detachment of the notes from the block in comparison with other surfaces on which the notes are applied. In the case of using the adhesive formulations according to the invention and the products produced therewith, the release layer can be dispensed with since the transfer of adhesive is negligible. In order to ensure particularly easy detachment from the block with at the same time a higher required adhesive force on other substrates, it can however be sensible also to use a release layer.

Furthermore, the invention includes the use of the adhesive composition for coating objects and/or carrier materials for the production of self-adhesive objects. Furthermore, protective films for sensitive surfaces, such as e.g. lenses, displays or polished metals, are preferred objects. The adhesive formulations are well suited also for fixing components for mechanical machining thereof. Particularly preferred here are carrier films which are equipped to be self-adhesive on both sides and which are situated during machining of the components between these and the workpiece carrier. These films can have a self-adhesive layer with a different adhesive force on both sides in order thus to achieve specific detachment on one side. For applications of this type, also rubber-elastic carrier films are very suitable for the adhesive. These can then be drawn out of the gap between the component and the workpiece carrier particularly easily with the help of a gripper.

As object with an adhesive layer according to the present application, there should be understood in particular also modular information systems, as are disclosed in WO 2005/073883 A2 which are referred to in their entirety with respect to the carrier material coated with adhesive.

The object with an adhesive layer according to the invention is distinguished in particular in that the adhesive layer preferably has a surface adhesiveness (measured according to DIN EN 1721) of 5 to 20 cm. Furthermore, the object with an adhesive layer is distinguished in that the peeling force on coated printing paper as substrate according to DIN EN 28510 is preferably at most 0.06 N/mm, particularly preferred 0.008 to 0.016 N/mm.

### EXAMPLES

The invention is described subsequently in more detail with reference to examples without restricting the generality.

Testing Methods used for Assessment

Coatings were prepared on heavily coated paper (printing paper A4, 80 g/m² by Xerox). The adhesive preparation was hereby knife-coated by a film drawing device with a nominal layer thickness of ˜250 μm and a width of 15 cm on a DIN A4 paper. After the knife-coating and drying of the adhesive film, the wetting and film-forming properties of the individual dispersions were tested. The following evaluation scale for the wetting and film homogeneity was applied:

| | |
|---|---|
| +++ | very good |
| ++ | good |
| + | less good |
| − | poor |

The resulting adhesive forces were determined by different methods.

A) Surface Adhesiveness:

The surface adhesiveness of the adhesives was determined following the “rolling balls” method (DIN EN 1721). The distance which a rolling ball covers on a horizontal adhesive layer after it has been released from a defined sloping surface is hereby measured.

A steel ball with a diameter of 7 mm (1.4 g) was used for the test and was rinsed with acetone and dried after each measurement. The result was determined form the average of three measurements and converted into the following evaluation diagram:

Adhesiveness (dry film):

| | | |
|---|---|---|
| 0-5 cm = | 1 = | very high adhesiveness |
| 5-10 cm = | 2 = | good adhesiveness |
| 10-15 cm = | 3 = | average adhesiveness |
| 15-20 cm = | 4 = | low adhesiveness |
| 20-25 cm = | 5 = | no adhesiveness |

B) Peeling Test

The adhesive force of the papers equipped to be adhesive was determined by a peeling test, manually or following the 180° peeling test according to DIN EN 28510. Bonds were hereby produced with the measurements 3 cm×21 cm, the adhesive film having been conditioned in advance at room temperature (for approx. 20 h). The bond was tested immediately after joining and conditioning and evaluated as follows.

Adhesion (manual peeling test)
1=very high
2=high
3=average
4=low
5=none

There was used as counterpart to the paper equipped to be adhesive uncoated printing paper or papers with commercially available release layers (side of adhesive notes by the company 3M not equipped to be self-adhesive). If no data relating to the paper are contained subsequently, untreated printing paper is involved.

C) Block Formation Test

For the block formation test, 10 strips of 12 cm×1.5 cm were produced with a one-sided adhesive layer, glued one above the other and weighed down for 3 days with approx. 11 kg. Subsequent thereto, a test was done as to whether the paper strips could be separated from each other or if block formation occurred. This test is relevant for the unwinding behaviour of paper rolls or the withdrawing of individual sheets from blocks. No block formation must occur.

In the following the polymer dispersions and inorganic particles used in the examples are described. Dispersions, the adhesive strength of which is already lower without addition of the inorganic particles than with many other adhesive dispersions, were selected for the tests.

TABLE 1
Polymer dispersions selected for the application examples

| | | | Glass transition | | |
|---|---|---|---|---|---|
| Product name | Description | Polymer content | temperature | | Viscosity |
| Planatol | Polyacrylate | 58% by weight | ≦0° | C. | 600 mPa · s |
| HW 450 | | | | | (according to |
| | | | | | Haake RS 50, |
| | | | | | ISO 3219 at 20° C.) |
| Collano DP | Polyacrylate | 55% by weight | −45° | C. | 2000 mPa · s |
| 1606 | | | | | (20° C., spindle 3, |
| | | | | | 20 rpm) |
| Collano DP | Polyacrylate | 55% by weight | ≦0° | C. | 2000 ± 600 mPa · s, |
| 7027 | | | | | (20° C., |
| | | | | | Brookfield, |
| | | | | | spindle 4, 50 rpm |
| Collano DP | Polyacrylate | 55% by weight | ≦0° | C. | 17 ± 2 Pa · s (20° C., |
| 7024 | | | | | Brookfield, |
| | | | | | spindle 5, 20 rpm |

TABLE 2
Overview of the inorganic particles selected for the application examples
for reduction in adhesive force:

| Manufacturer | Product name | Description |
|---|---|---|
| H. C. Starck | Levasil A200/40% | SiO₂ Specific surface: |
| | | 200 m²/g |
| | | Particle size; |
| | | 15 nm (primary particle size) |
| Quarzwerke | Quarzmehl | SiO₂ |
| GmbH | SF 800 | Particle size: |
| | | D50% = 2 μm, |
| | | D95% = 6 μm |
| Eduard Merkle | Ulmer Weiβ | Natural calcium carbonate |
| GmbH & CO. KG | | from limestone |
| | | Particle size: |
| | | D50% = 3 μm, |
| | | D99% = 12 μm |
| Omya AG | Omyacarb 6-AL | Natural calcium carbonate |
| | | from limestone |
| | | Particle size; |
| | | D50% = 4.8 μm, |
| | | D98% = 27 μm |

### Example 1

### Comparison: Adhesive Properties of the Polymer Dispersion Without the Addition of Inorganic Particles

With the polymer dispersions (Table 1), layers were prepared on heavily coated paper and dried at room temperature (25° C.). The surface adhesiveness of the dried adhesive films on paper and the adhesive force relative to uncoated printing paper were determined. The test results are displayed in Table 3.

TABLE 3
Results relating to determination of the adhesive force of different
polymer dispersions

| | | Film | Surface | Manual peeling |
|---|---|---|---|---|
| Adhesive | Wetting | homogeneity | adhesiveness | test |
| Collano DP 1606 | +++ | +++ | 2 | 3 |
| Planatol HW 450 | +++ | +++ | 2 | 3 |

### Example 2

### According to the Invention

Influence of different inorganic particles on the adhesive properties of the adhesive preparations

In order to test the effect of inorganic particles, 5% by weight of the respective particles, relative to the polymer dispersion, were dispersed in the selected adhesive dispersions Collano DP 1606 and Planatol HW 450. Papers with self-adhesive coating, as described in example 1, were prepared and tested (Table 4). In all cases the desired reduction in adhesive strengths is achieved.

TABLE 4
Test for reduction in adhesive force of Collano DP 1606 and Planatol
HW 450 by addition of 5% fillers

| | | | | |
|---|---|---|---|---|
| | | Film | Surface | Manual |
| Composition | Wetting | homogeneity | adhesiveness | peeling test |

Collano DP 1606 with:

| | | | | |
|---|---|---|---|---|
| Levasil A200/40% | +++ | +++ | 4 | 3 |
| Quarzmehl SF 800 | +++ | +++ | 3 | 3 |
| Omnicarb 6-A1 | +++ | +++ | 4 | 3 |
| Ulmer Weiβ | +++ | +++ | 3 | 3 |

Planatol HW 450 with:

| | | | | |
|---|---|---|---|---|
| Levasil A200/40% | +++ | ++ | 4 | 4 |
| Quarzmehl SF 800 | +++ | ++ | 3 | 4 |
| Omnicarb 6-A1 | +++ | ++ | 3 | 4 |
| Ulmer Weiβ | +++ | ++ | 3 | 3 |

### Example 3

### Variation in Concentration of the Inorganic Particles

In the following tests, the concentration of inorganic particles as supplements for adjusting the adhesive properties was varied and the resulting properties of the adhesive films were determined.

The preparation was effected as described in the previous examples. The composition of the individual formulations is described in the following Table 5.

TABLE 5
Adhesive properties of Planatol HW 450 with the addition of various
inorganic particles

| | | | | |
|---|---|---|---|---|
| | | | | Peeling |
| | | | | test |
| | | | | possibly |
| | | Film | Surface | release |
| Composition | Wetting | homogeneity | adhesiveness | paper |

Planatol HW 450 with:

| | | | | |
|---|---|---|---|---|
| 0.5% Quarzmehl SF 800 | +++ | +++ | 2 | 3 |
| 1% Quarzmehl SF 800 | +++ | +++ | 3 | 3 |
| 3% Quarzmehl SF 800 | +++ | +++ | 3 | 3 |
| 5% Quarzmehl SF 800 | +++ | +++ | 3 | 3-4 |
| 6% Quarzmehl SF 800 | +++ | +++ | 3 | 3 |
| 9% Quarzmehl SF 800 | +++ | +++ | 4 | 2 |
| 10% Quarzmehl SF 800 | +++ | +++ | 3 | 2 |
| 12% Quarzmehl SF 800 | +++ | +++ | 4 | 2 |
| 15% Quarzmehl SF 800 | +++ | +++ | 4 | 2 |
| 18% Quarzmehl SF 800 | +++ | +++ | 4 | 2 |
| 20% Quarzmehl SF 800 | +++ | +++ | 4 | 2 |

The adhesive films display, under contact pressure of approx. 100 N, no inclination to block formation and, relative to untreated paper, likewise have a low adhesion force.

### Example 4

### Test of Collano DP 7024 as Polymer Dispersion

In this example, the adhesive force of Collano DP 7024 is adjusted by addition of Levasil A200. The results are displayed in Table 6. Levasil A200, i.e. a product with nanoscale inorganic particles, has a great influence on the adhesive force. The adhesive force of Collano DP 7024 can be adjusted very well with this product. The adhesive force was able to be reduced so far that it was no longer determinable via the available measuring technology (smallest available load cell).

TABLE 6
Adjustment of the adhesive force of Collano DP 7024

| | | Average peeling force |
|---|---|---|
| Composition | Homogeneity | [N/mm] |
| 10% Levasil A200/40% | +++ | 0.01 |
| 15% Levasil A200/40% | +++ | 0.01 |
| 20% Levasil A200/40% | +++ | 0.00 |
| 15% Levasil A200/40% | +++ | 0.00 |

The papers equipped to be adhesive and produced in this example showed no block formation in the block formation test. After the test, the individual sheets could furthermore be separated from each other easily. Likewise, papers equipped with these formulations can be removed from metals very easily and without residue. A significant transfer of adhesive during mechanical transport of paper rolls equipped to be adhesive, e.g. in cash registers, should consequently not be anticipated.

1. A coated flat object comprising carrier material and coating,
the coating comprising (i) a polymer film, wherein the polymer film is not soluble in a 48-hour treatment at room temperature with a solvent suitable for corresponding oligomers of the monomers contained in the polymer film up to at least 50%, relative to the total polymer content,
and wherein the polymer has a glass transition temperature of less than 20° C.; and (ii)
inorganic particles with an average primary particle size between 1 nm and 50 μm.

2. The coated flat object according to claim 1, wherein the polymer film is not soluble up to at least 80%.

3. The coated flat object according to claim 1, wherein the polymer is used in the form of a dispersion, the particles of which have an average size of 20 to 700 nm.

4. The coated flat object according to claim 1, wherein the polymer is selected from the group consisting of polyisoprene, polybutadiene, polyisobutylene, polydimethylsiloxane, polyurethane, polyacrylate, polymethylacrylate, polymers based on acrylic acid, polymers based on methacrylic acid, polymers based on styrene, acrylic-containing copolymers, methacrylic-containing copolymers and any mixture thereof.

5. The coated flat object according to claim 1, wherein the polymer is not based on chloroprene.

6. The coated flat object according to claim 1, wherein the inorganic particles have an average primary particle size between 1 nm and 5 μm.

7. The coated flat object according to claim 1, wherein the inorganic particles are selected from the group comprising oxides, silicates, metal salts and mixtures thereof.

8. The coated flat object according to claim 1, wherein the carrier material is selected from the group consisting of paper, thermopaper, cardboard, plastic material film, composite film, protective film and mixtures thereof.

9. The coated flat object according to claim 8, wherein the carrier material has a basis weight between 5 and 250 g/m².

10. The coated flat object according to claim 8, wherein the coated carrier material is present as a stack and/or roll.

11. The coated flat object according to claim 8, wherein the carrier material has an uncoated side that does not include an anti-adhesive layer.

12. An adhesive composition for coating flat objects comprising
(i) a polymer dispersion, wherein the polymer contained in the polymer dispersion has a glass transition temperature of less than 20° C., and
(ii) inorganic particles with an average primary particle size between 1 nm and 50 μm.

13. canceled

14. The adhesive composition according to claim 12, wherein the polymer dispersion is aqueous and has a solids content of 10 to 70%.

15. The adhesive composition according to claim 12, wherein the proportion of inorganic particles, relative to the polymer content of the polymer dispersion, is 0.1 to 50% by weight.

16. A method of coating an object comprising:
(i) providing a carrier material;
(ii) applying the adhesive composition of claim 12 to the carrier material to form a coated object comprising
(a) a polymer film, wherein the polymer film is not soluble in a 48-hour treatment at room temperature with a solvent suitable for corresponding oligomers of the monomers contained in the polymer film up to at least 50%, relative to the total polymer content,
and wherein the polymer has a glass transition temperature of less than 20° C.; and
(b) inorganic particles with an average primary particle size between 1 nm and 50 μm.

17. The method of claim 16, wherein the polymer dispersion is aqueous and has a solids content of 10 to 70%.

18. The method of claim 16, wherein the proportion of inorganic particles, relative to the polymer content of the polymer dispersion is 0.1 to 50% by weight.

19. The coated flat object according to claim 2, wherein the polymer film is not soluble up to at least 90%.
